(19) United States
(12) Patent Application Publication
(10) Pub. No.: US 2006/0263262 A1
(43) Pub. Date: Nov. 23, 2006

(54) Microfluidics structure and method

(76) Inventor: Vladimir J. Drbal, Belmont, CA (US)

Correspondence Address: PERKINS COIE LLP, P.O. BOX 2168, MENLO PARK, CA, 94026, US

(21) Appl. No.: 11/401,698

(22) Filed: Apr. 10, 2006

Related U.S. Application Data
(60) Provisional application No. 60/670,478, filed on Apr. 11, 2005.

(51) Int. Cl. B01L 3/02

(52) U.S. Cl. 422/100

(57) ABSTRACT

A liquid-filled microfluidics assembly and method of forming the same are disclosed. The assembly includes a non-metallic substrate having a liquid-filled microfluidics structure that includes a microchannel and a chamber in fluid communication therewith, and a metal tube embedded in the substrate, communicating with the chamber and sealed by crimping at a region along its length, thus to seal the structure adjacent the chamber. In forming the assembly, a polymer substrate having a microfluidics structure including a microchannel and a chamber in fluid communication therewith is molded around a metal tube communicating the chamber with a port at which liquid can be drawn or pumped into the structure. The structure is filled by drawing or pumping liquid into the structure through the port, and liquid in the structure, adjacent the chamber, is sealed by crimping the tube.

This patent application claims priority to U.S. provisional patent application No. 60/670,478 filed Apr. 11, 2005, which is incorporated herein in its entirety by reference.

### FIELD OF THE INVENTION

The present invention relates to a microfluidics assembly and method of forming same.

### SUMMARY OF THE INVENTION

The invention includes, in one aspect, an assembly having microfluidics structure designed to prefilled with a liquid. The assembly includes a non-metallic substrate having such microfluidics structure, and a metal tube embedded in the substrate communicating the structure with a port at which liquid can be drawn or pumped into the structure through the tube. The substrate provides access to the tube along a portion of its length for applying mechanical force thereto, after pre-filling the structure with a liquid, to seal the tube.

For use in a diagnostics device for detecting a sample analyte, the microfluidics structure includes a microfluidics channel and a chamber in liquid communication with both the channel and the tube, and the device further includes a sample-receiving well in liquid communication with the upstream end of the microchannel, when the device is in operative condition. The assembly may include, in its prefilled condition, a removable seal disposed between the well and microchannel, for maintaining liquid in the structure in a sealed condition.

The chamber in the microfluidics structure may have a depth substantially greater that of the depth of the microchannel, and the chamber may communicate with the microfluidics channel and the tube, at upper and lower chamber regions, respectively.

The substrate may be formed by polymer injection molding, and the assembly may further include a mandrel contained within the metal tube during the molding. The mandrel may extend between an interior end of the tube and the microfluidics structure, such that removal of the mandrel after injection molding produces a fluid-flow channel between the tube and structure. The mandrel may be coated by a lubricious coating material that facilitates removal of the mandrel in the region of the polymer forming the fluid-flow channel.

The metal tube may terminate, at its outer end, in a fitting which is connectable to a liquid delivery device.

Also disclosed is a prefilled microfluidics assembly composed of a non-metallic substrate having a liquid-filled microfluidics structure, and a metal tube embedded in the substrate communicating with the structure and sealed by crimping at a region along its length.

Where the microfluidics structure includes a microfluidics channel and a chamber in liquid communication with both the channel and the tube, the device may further include a sample-receiving well separated from the upstream end of the microfluidics channel by a removable seal. The chamber may have a depth substantially greater that of the depth of the microchannel, and the chamber may communicates with the microfluidics channel and the tube, at upper and lower chamber regions, respectively.

Where the assembly is formed by an injection-molded polymer, the structure may include a channel section extending between the chamber and the metal tube.

In another aspect, the invention includes a method of producing a substrate having a sealed, liquid-filled microfluidics structure. The method includes the steps of molding a polymer substrate having a microfluidics structure, and during the molding, embedding in the substrate a metal tube communicating the structure with a port at which liquid can be drawn or pumped into the structure through the tube. The structure is then filled by drawing or pumping liquid into the structure through the port, and sealed by crimping the metal tube at a point along its length.

For use in producing a diagnostics device for detecting a sample analyte, the microfluidics structure may include a microfluidics channel and a chamber in liquid communication with both the channel and the tube, and the structure may further include a sample receiving well in liquid communication with the upstream end of the microfluidics channel, when the device is in operative condition. The method may further include forming a removable seal between the sample-receiving well and the microfluidics channel after the microfluidics structure is filled.

The metal tube may be provided with a mandrel within the tube, extending beyond the inner end of the tube, and the method may further include removing the mandrel, thus to form a fluid-flow channel in the substrate extending between the chamber and the inner end of the tube, and/or between the outer end of the tube and the outer surface of the mandrel. The mandrel may be coated by a lubricious coating material that facilitates removal of the mandrel in the region of the polymer forming the fluid-flow channel.

The metal tube may terminate at its outer end in a fitting which is connectable to a fluid-delivery device, and the filling may include connecting the liquid delivery device to the fitting, and drawing or pumping liquid therethrough.

In still another aspect, the invention includes a method of forming a microfluidics channel within a molded polymer structure, by placing within a polymer mold, at a selected location therein, a metal tube having an inner-diameter dimension in the range 50-250 microns, and a mandrel slidably held therein, the mandrel extending beyond at least one of the tube ends. After filling the mold with a polymer, thus to embed the tube and optionally, a portion of the mandrel in the polymer, and after polymer hardening, the mandrel is removed from the tube, thus forming within the tube and any embedded portion of the mandrel, a microfluidics channel.

For use in forming a microfluidics channel having a desired curved or bent shape, the tube and/or mandrel may have such curved or bent shape when placed in the mold. Where a portion of the mandrel embedded in the polymer, the mandrel may be coated by a lubricious coating material that facilitates removal of the mandrel in the region of the polymer embedding.

These and other objects and features of the invention will become more fully apparent when the following detailed description of the invention is read in conjunction with the accompanying drawings.

### BRIEF DESCRIPTION OF THE DRAWINGS

FIG. 1 is a perspective view of a molded diagnostic device constructed according to one embodiment of the invention, showing the filling of microfluidics structure within the device;

FIG. 2 is a side sectional view of the device seen in FIG. 1;

FIG. 3 is an enlarged view of microfluidics structure seen in FIG. 2; and

FIGS. 4A and 4B are perspective and sectional views, respectively, showing the metal tube in the device in a crimped condition.

### DETAILED DESCRIPTION OF THE INVENTION

A. Definitions

The term “microfluidics structure” is used herein indicate a structure having at least one component, and typically a microchannel component, with depth and width dimensions in the range of about 250 microns or less, e.g., 5-150 microns, and that support fluid-flow behavior characteristic of microfluidics channels.

The term “prefilled” as applied to a microfluidics structure means that the structure is filled with a liquid, e.g., physiological saline, during manufacture and supplied in an already filled form. A prefilled assembly is sealed to retain the liquid therein.

B. Microfluidics Assembly

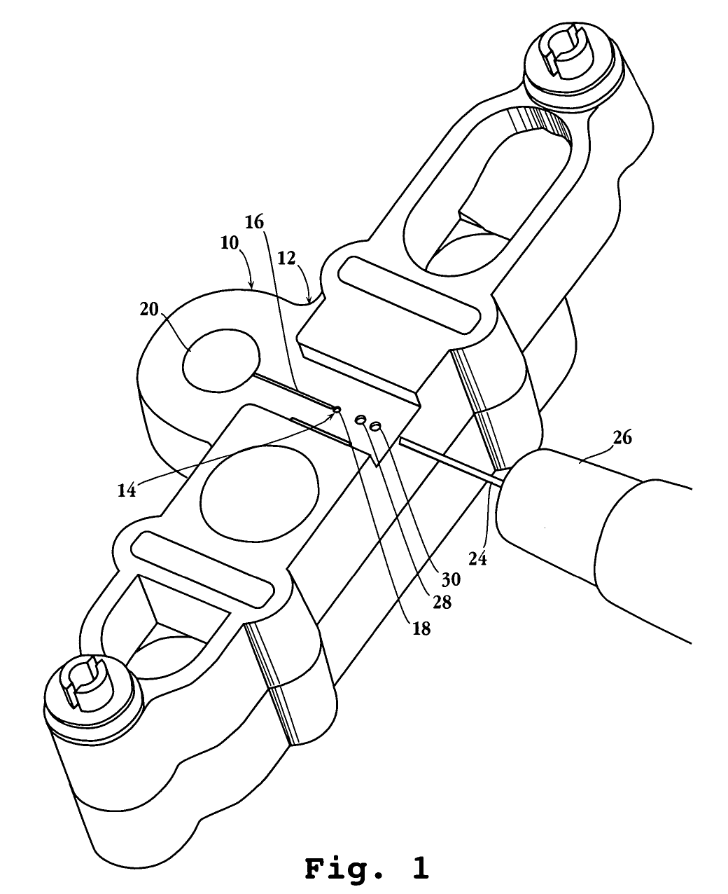

FIG. 1 is a perspective view of portions of a microfluidics assembly 10 constructed in accordance with the present invention and designed for use in a diagnostics device, such as the device described in U.S. patent application 20040146850, published Jul. 29, 2004 entitled Male Fertility Assay Method and Device, now U.S. Pat. No. 6,929,945 issued Aug. 16, 2005, which application is incorporated herein in its entirety. The device described in the above-noted application is designed for measuring the motility and density of sperm in a male semen sample, by measuring the flux of sperm through a microchannel, as evidenced by the accumulation of fluorescent-labeled in a detection chamber at the downstream end of the channel. It will be appreciated, however, how the present invention can be adapted to virtually any prefilled fluid-handling device for measuring chemical or biological events occurring in the prefilled regions of the device.

With reference to FIGS. 1-3, device 10 generally includes a non-metallic substrate 12, e.g., a polymer or ceramic substrate that defines or contains a microfluidics structure 14 designed to be filled with a liquid, typically an analyte-compatible physiological solution, such as a buffered aqueous solution. In the assembly shown, microfluidics structure 14 includes a microfluidics channel or microchannel 16 and a chamber 18 in fluid communication with the microchannel. Channel 14 has width and depth dimensions typically between 10-250 microns. Where, for example, the device is used for measuring sperm motility and density, by sperm migration along the microchannel, the microchannel has width and depth dimensions each between about 10-100 microns, preferably in the range 15-60 microns.

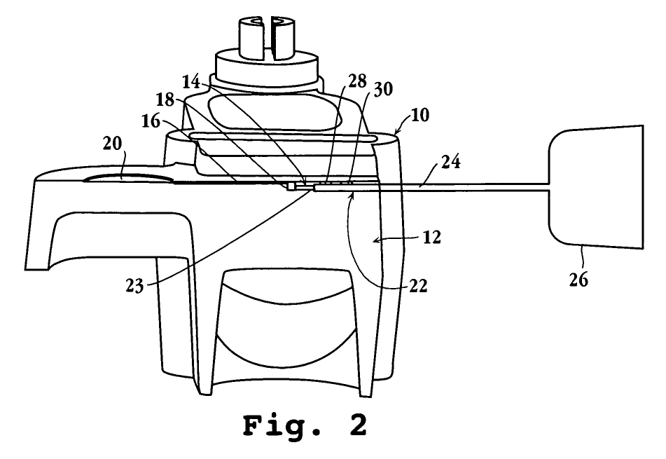

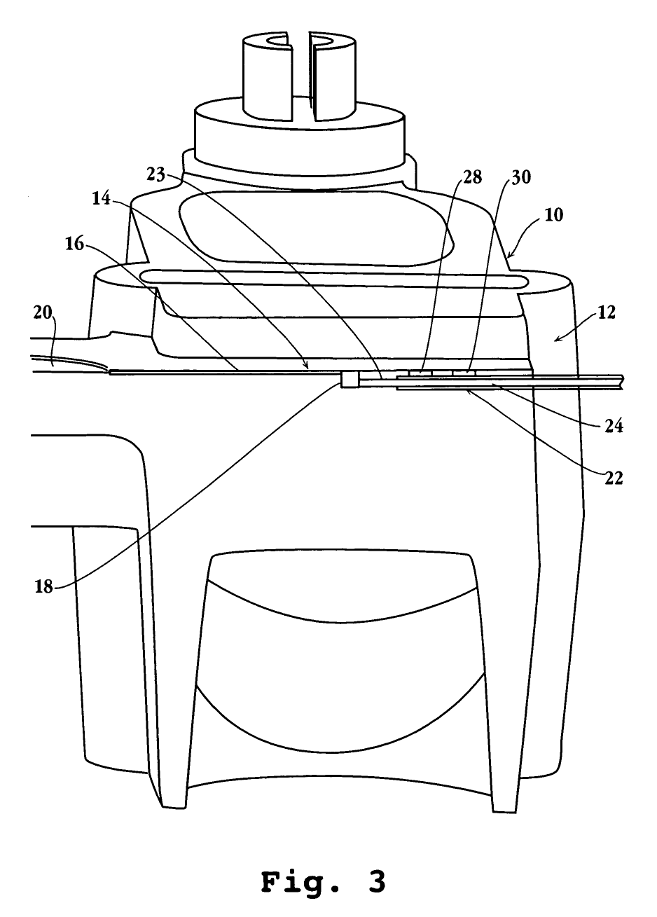

As seen best in FIGS. 2 and 3, microchannel 14 communicates at its downstream end with a chamber 18, at the upper portion of the chamber, which has a depth substantially greater, e.g., several times greater than that of the microchannel. In an exemplary embodiment, the chamber reservoir has a cylindrical radius of between 0.1 and 1 mm, and a depth of between 0.1 and 1 mm, to produce a known volume of between 0.001 and 1 mm³.

Also formed in substrate 12, and communicating with the upstream end of channel 14, is a sample-receiving well 20 at which analyte-containing sample is applied to the device. In its stored condition, the microfluidics structure is filled with a suitable analyte compatible liquid, and a removable seal at the upstream end of the microchannel acts to seal this liquid within the microfluidics structure. Just prior to use, this seal is removed and liquid sample is placed in the sample-receiving well, to bring the sample into fluid contact with the liquid in the prefilled microchannel.

Also forming part of device 10, and as seen best in FIGS. 2-4, is a channel 22 which communicates with a lower portion of chamber 20. At least a portion of channel 22 is formed by a metal tube 24, such as a small-diameter stainless steel hypodermic syringe needle, that is embedded within the device substrate and which terminates at its outer end (see FIGS. 1 and 2) in a syringe fitting or hub 26, through which liquid can be drawn and pumped into the device's microfluidics structures. Metal tubes having inner diameters of between about 50-300 microns and forming of a malleable metal such as stainless steel or aluminum are suitable. In the embodiment shown, the metal tube terminates at its inner end short of chamber 18, with an interior section 23 of the channel being formed within the substrate itself. As will be seen below, channel section 23 is formed by a mandrel that is placed within the tube during substrate formation.

The mandrel diameter is close fitting to the inner diameter of the metal tube, and the mandrel's inner end portion extends beyond the inner end of the tube a distance corresponding to section 23. After the substrate hardens and is removed from the mold, the mandrel is removed to form channel section 23.

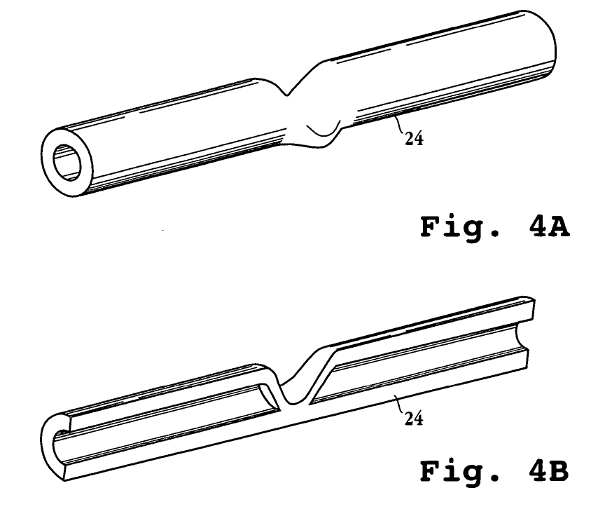

The substrate is designed to provide access to tube 24 at one or more positions along its length. In the embodiment shown, this access is provided by openings 28, 30 formed in the substrate. This access allows a mechanical crimping device to be placed against the tube, for closing and sealing the tube by crimping at one or more positions along its length. As will be described further below, tube 24 is closed and sealed by crimping once the device's microfluidics structure has been filled with liquid, thus to seal the downstream end of the liquid-filled microfluidics structure. FIGS. 4A and 4B show the condition of tube 24 after crimping. As seen, the crimping is effective to produce a fluid-tight seal.

It will be appreciated that the structures shown in FIGS. 1-3 represent the assembly during production, with the upstream and downstream ends of the microfluidics channel being open. As described below, the microfluidics structure in the device is filled either by drawing liquid into the structure, from its upstream end, by applying a negative pressure (vacuum) to the port, or by pumping liquid into the port under a positive pressure, to fill the microfluidics structure from the port side of the structure. Once the assembly is filled, metal tube 24 is crimped in one or more places along its length to seal the downstream end of the structure, and a removable seal is placed at the upstream end of microchannel 14, to seal the upstream end of the structure. To complete the production of the assembly, the end of the tube sticking out of the substrate is cut, removing the filling port.

C. Method of Producing a Microfluidics Assembly

In another aspect, the invention includes a method of forming a microfluidics assembly of the type described above. The method includes embedding a metal tube of the type described above in a molded polymer substrate, such that the metal tube forms at least a portion of a fluid-flow channel within the substrate. The metal tube typically is provided with a mandrel that is close fitting in diameter with the tube, so as to substantially prevent flow of polymer into the tube during molding. The mandrel sticks out of the tube at least at the tube's outer end, to allow the mandrel to be withdrawn from the tube after molding. The mandrel may also project a desired distance beyond the inner end of the tube, in forming a portion of the flow channel that is continuous with the channel formed by the metal tube, as seen in the assembly above.

As noted above, suitable metal tubes have inner diameters of between about 2 mils (about 50 microns) and up to 12 miles (about 300 microns) or larger, with lengths ranging from a few millimeters to one or more centimeters. The tube is preferably formed of a stainless malleable metal, such as stainless steel hypodermic syringe needle or an aluminum tube or needle. The table below gives outer and inner diameters of standard sized, commercially available hypodermic syringe needles. Needles having a gauge of between 27-33 are generally considered small-bore needles, and those with gauges between 22-26, larger-bore needles.

| Gauge | inch | mm* | inch | mm* | inch | mm* | μL/inch |
|---|---|---|---|---|---|---|---|
| 33 | .0080-.0085 | 0.21 | .0035-.0050 | 0.11 | .002 | .05 | .20 |
| 32 | .0090-.0095 | 0.24 | .0035-.0050 | 0.11 | .002 | .05 | .20 |
| 31 | .0100-.0105 | 0.26 | .0045-.0060 | 0.13 | .0025 | .06 | .34 |
| 30 | .0120-.0125 | 0.31 | .0055-.0070 | 0.16 | .003 | .08 | .45 |
| 28 | .0140-.0145 | 0.36 | .0065-.0080 | 0.18 | .0035 | .09 | .63 |
| 27 | .0160-.0165 | 0.41 | .0075-.0090 | 0.21 | .004 | .10 | .80 |
| 26s | .0184-.0189 | 0.47 | .0045-.0055 | 0.13 | .007 | .18 | .26 |
| 26 | .0180-.0185 | 0.46 | .0095-.0110 | 0.26 | .004 | .10 | 1.25 |
| 25 | .0200-.0205 | 0.51 | .0095-.0110 | 0.26 | .005 | .13 | 1.25 |
| 24 | .0220-.0225 | 0.57 | .0115-.0130 | 0.31 | .005 | .13 | 1.80 |
| 23 | .0250-.0255 | 0.64 | .0125-.0140 | 0.34 | .006 | .15 | 2.17 |
| 22s | .0280-.0285 | 0.72 | .0055-.0065 | 0.15 | .011 | .28 | .45 |
| 22 | .0280-.0285 | 0.72 | .0155-.0170 | 0.41 | .006 | .15 | 3.35 |
| 21 | .0320-.0325 | 0.82 | .0195-.0210 | 0.51 | .006 | .15 | 5.19 |
| 20 | .0355-.0360 | 0.91 | .0230-.0245 | 0.60 | .006 | .15 | 6.71 |
| 18 | .0495-.0505 | 1.27 | .0315-.0345 | 0.84 | .0085 | .22 | 14.08 |
| 17 | .0575-.0580 | 1.47 | .0405-.0435 | 1.07 | .008 | .20 | 22.84 |
| 16 | .0645-.0655 | 1.65 | .0455-.0485 | 1.19 | .009 | .23 | 28.25 |
| 14 | .0820-.0840 | 2.11 | .0610-.0600 | 1.60 | .010 | .25 | 51.07 |
| 13 | .0940-.0960 | 2.41 | .0690-.0730 | 1.80 | .012 | .31 | 64.63 |
| 12 | .1080-.1100 | 2.77 | .0830-.0870 | 2.16 | .012 | .31 | 93.07 |
| 11 | .1190-.1210 | 3.05 | .0920-.0960 | 2.39 | .013 | .33 | 113.00 |
| 10 | .1330-.1350 | 3.40 | .1040-.1080 | 2.69 | .014 | .36 | 143.28 |

*mm are nominal

Similarly, the mandrel contained in the tube during molding has an outer diameter of between 50-300 microns or more and is typically relatively tight fitting within the tube, that is, slidable within the tube but with a close tolerance. The mandrel is formed of a metal or composite wire having relatively high tensile strength, allowing the mandrel to be withdrawn from the tube and substrate after assembly molding. Where the mandrel is intended to at least partially coated during the substrate molding process, the mandrel itself may be coated with a lubricious coating material, such as Teflon or polyethylene, to facilitate its removal from the substrate after polymer hardening.

An advantage of using a hypodermic syringe needle for the metal tube is that the needle provides a filling hub or fitting to which a filling device such as a syringe can be easily attached. Then, after filling the microfluidics structure, and sealing the tube by crimping, the hub end of the needle sticking out beyond the surface of the substrate can be cut off.

In one embodiment, the tube and/or mandrel may be shaped or bent in a desired curved path, for forming a curved channel within the substrate. Where the metal tube is designed for producing a microfluidics channel, the tube has an inner diameter in the microfluidics channel diameter range, e.g., 25-300 microns, typically 50-150 microns, and the mandrel is sized accordingly to fit within the channel.

In one general embodiment, the substrate is formed by injection molding of a suitable polymer, such as polypropylene, polycarbonate, or the like. The mold defines the substrate structures to be formed, and the metal tube and mandrel and positioned and held within the mold at a desired position and orientation. After hardening of the polymer material, the substrate is removed from the mold, and the mandrel removed from the metal tube, producing the assembly described in FIGS. 1-3. The microfluidics structure in the substrate in then filled with a suitable liquid, either by drawing or pumping liquid through the port on the metal tube, until the microfluidics structure is filled, preferably to a point when all gas bubbles have been removed. The metal tube is then sealed, by mechanical crimping, and the opposite end of the structure sealed, e.g., by a removable polymer seal.

While the assembly and its method of making have been described with respect to particular embodiments, it will be appreciated that various changes and modifications may be made without departing from the invention.

It is claimed:

1. An assembly having microfluidics structure designed to prefilled with a liquid, said assembly comprising
a non-metallic substrate having such microfluidics structure, and
a metal tube embedded in said substrate communicating said structure with a port at which liquid can be drawn or pumped into said structure through said tube,
said substrate providing access to said tube along a portion of its length for applying mechanical force thereto, after pre-filling said structure with a liquid, to seal the tube.

2. The assembly of claim 1, for use in a diagnostics device for detecting a sample analyte, wherein said microfluidics structure includes a microfluidics channel and a chamber in liquid communication with both said channel and said tube, and the device further includes a sample-receiving well in liquid communication with the upstream end of said microchannel, when the device is in operative condition.

3. The assembly of claim 2, which further includes, in its prefilled pre-operative condition, a removable seal disposed between said well and microchannel, for maintaining liquid in said structure in a sealed condition.

4. The assembly of claim 2, wherein said chamber has a depth substantially greater that of the depth of said microchannel, and said chamber communicates with said microfluidics channel and said tube, at upper and lower chamber regions, respectively.

5. The assembly of claim 1, wherein said substrate is formed by polymer injection molding, and which further includes a mandrel contained within said metal tube during said molding.

6. The assembly of claim 5, wherein said mandrel extends between an interior end of said tube and said microfluidics structure, wherein removal of the mandrel after injection molding, produces a fluid-flow channel between the said tube and structure.

7. The assembly of claim 6, wherein said mandrel is coated by a lubricious coating material that facilitates removal of the mandrel in the region of the polymer forming said fluid-flow channel.

8. The assembly of claim 1, wherein said metal tube terminates, at its outer end in a fitting which is connectable to a liquid delivery device.

9. A prefilled microfluidics assembly comprising
a non-metallic substrate having a liquid-filled microfluidics structure, and
a metal tube embedded in said substrate communicating with said structure and sealed by crimping at a region along its length.

10. The assembly of claim 9, wherein said microfluidics structure includes a microfluidics channel and a chamber in liquid communication with both said channel and said tube, and the device further includes a sample receiving well separated from the upstream end of said microfluidics channel by a removable seal.

11. The assembly of claim 10, wherein said chamber has a depth substantially greater that of the depth of said microchannel, and said chamber communicates with said microfluidics channel and said tube, at upper and lower chamber regions, respectively.

12. The assembly of claim 11 which is formed by an injection-molded polymer and said structure includes a channel section extending between said chamber and said metal tube.

13. A method of producing a substrate having a sealed, liquid-filled microfluidics structure, comprising
molding a polymer substrate having a microfluidics structure, and
during said molding, embedding in said substrate a metal tube communicating said structure with a port at which liquid can be drawn or pumped into said structure through said tube,
filling said structure by drawing or pumping liquid into said structure through said port, and
sealing the metal tube by crimping the tube at a point along its length.

14. The method of claim 13, for use in producing a diagnostics device for detecting a sample analyte, wherein said microfluidics structure includes a microfluidics channel and a chamber in liquid communication with both said channel and said tube, and the device further includes a sample receiving well in liquid communication with the upstream end of said microfluidics channel, when the device is in operative condition, and which further includes forming a removable seal between said sample-receiving well and said microfluidics channel.

15. The method of claim 13, wherein said metal tube further includes a mandrel within the tube, extending beyond the inner end of said tube, and said method further includes removing said mandrel, thus to form a fluid-flow channel in said substrate extending between said chamber and the inner end of said tube.

16. The method of claim 15, wherein said mandrel is coated by a lubricious coating material that facilitates removal of the mandrel in the region of the polymer forming said fluid-flow channel.

17. The method of claim 13, wherein said metal tube terminates at its outer end in a fitting which is connectable to a fluid-delivery device, and said filling includes connecting the liquid delivery device to said fitting, and drawing or pumping liquid therethrough.

18. A method of forming a microfluidics channel within a molded polymer structure comprising
placing within a polymer mold, at a selected location therein, a metal tube having an inner-diameter dimension in the range 50-250 microns, and a mandrel slidably held therein, said mandrel extending beyond at least one of said tube ends,
filing said mold with a polymer, thus to embed the tube and optionally, a portion of said mandrel in the polymer,
after polymer hardening, removing the mandrel from said tube, thus forming within said tube and any embedded portion of said mandrel, a microfluidics channel.

19. The method of claim 18, for forming a microfluidics channel having a desired curved or bent shape, wherein said tube and/or mandrel has such curved or bent shape when placed in said mold.

20. The method of claim 19, wherein a portion of said mandrel is embedded in said polymer, and said mandrel is coated by a lubricious coating material that facilitates removal of the mandrel in the region of the polymer embedding.
